(19) United States
(12) Patent Application Publication
(10) Pub. No.: US 2007/0043655 A1
(43) Pub. Date: Feb. 22, 2007

(54) Incorporation of adverse selection in customized price optimization

(75) Inventors: Robert L. Phillips, Palo Alto, CA (US); Simon Caufield, London (GB)

Correspondence Address: VAN PELT, YI & JAMES LLP, 10050 N. FOOTHILL BLVD #200, CUPERTINO, CA, 95014, US

(73) Assignee: Nomis Solutions Inc.

(21) Appl. No.: 11/205,783

(22) Filed: Aug. 16, 2005

(51) Int. Cl. G06Q 40/00

(52) U.S. Cl. 705/38; 705/35

(57) ABSTRACT

Automatically evaluating a price is disclosed. A price sensitivity effect of the price is accounted for where increasing the price has a tendency to decrease an acceptance rate. An adverse selection effect of the price is accounted for where increasing the price has a tendency to increase a risk. The price is automatically evaluated based at least in part on the price sensitivity effect and the adverse selection effect.

### BACKGROUND OF THE INVENTION

Automated price optimization is a process to automatically determine a price that is optimized based on one or more factors. One factor often used is optimization of profit. Automated price optimization may be applied to a variety of products, services, and industries. In some applications, the price is a customized price, while in other applications the price is a list price. A customized price is a price customized for a particular customer and may be offered after an inquiry while a list price is offered to all customers and may be offered without a prior inquiry. Improvements to current automated price optimization techniques would be useful.

### BRIEF DESCRIPTION OF THE DRAWINGS

Various embodiments of the invention are disclosed in the following detailed description and the accompanying drawings.

FIG. 1 is a block diagram illustrating an embodiment of an automated price optimization system.

FIG. 2A is a chart illustrating an embodiment of expected profit determined with adverse selection and without adverse selection.

FIG. 2B is a chart illustrating risk associated with customers who accept a price with adverse selection and without adverse selection.

FIG. 3A is a distribution illustrating a customer dimension.

FIG. 3B is a description illustrating an embodiment of a product dimension.

FIG. 3C is a table illustrating an embodiment of preferred prices determined for segments.

FIG. 4A is a block diagram illustrating an embodiment of a profit model with independent components.

FIG. 4B is a block diagram illustrating an embodiment of a profit model with an incremental profit model coupled to an adverse selection model.

FIG. 4C is a block diagram illustrating an embodiment of a profit model with a price sensitivity model coupled to an adverse selection model.

FIG. 5 is a chart illustrating an embodiment of using a regression to obtain adverse selection data.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatically evaluating a price for a transaction and determining an optimal price for a transaction is disclosed. In some embodiments, a price sensitivity effect of the price and an adverse selection effect of the price are accounted for. The price sensitivity effect is the tendency of increasing the price to decrease an acceptance rate (or probability) of the transaction. The adverse selection effect is the tendency of a risk associated with the transaction to increase as price increases. For example, as price increases, the desirability of customers who accept the increased price tends to decrease. More desirable customers may select lower priced alternatives, leaving less desirable customers to accept the higher price. In some embodiments, the adverse selection affect is measured by a FICO or credit score or an expected credit loss per deal. Automatically evaluating the price may be based at least in part on the price sensitivity effect and on the adverse selection effect. In various embodiments, automatically evaluating the price is also based on additional information.

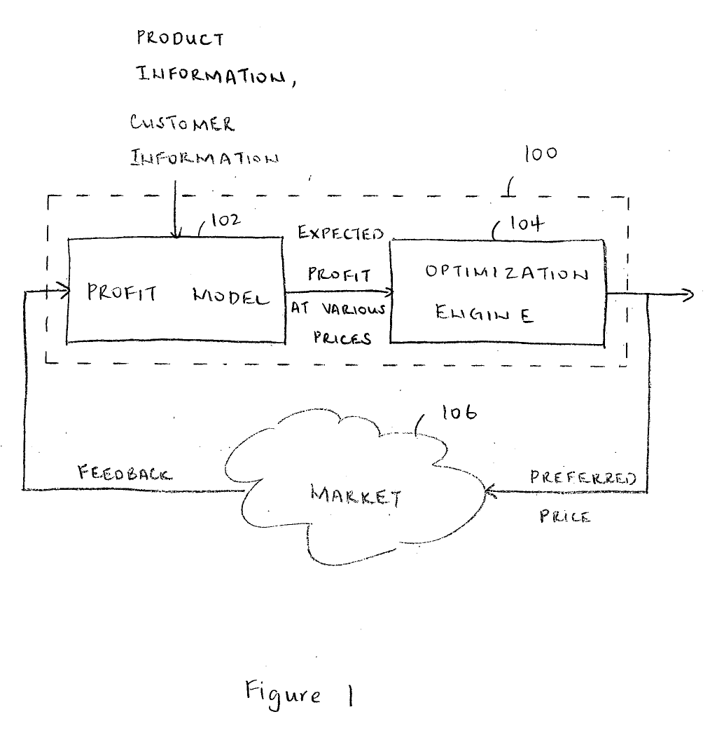

FIG. 1 is a block diagram illustrating an embodiment of an automated price optimization system. In the example shown, automated price optimization system 100 outputs a preferred price. Automated price optimization system 100 includes profit model 102 and optimization engine 104. Optimization engine 104 uses expected profit to determine the preferred price. For example, if optimization engine 104 optimizes profit and the expected profit is a function of price, then optimization engine 104 selects the price that maximizes the expected profit. The price selected by optimization engine 104 is the preferred price. The expected profit is output from profit model 102 and may be based on customer information, product information such as the product chosen by the customer, and feedback from using the preferred price in market 106.

A preferred price includes different components such as a fee or an interest rate in various embodiments. For example, the preferred price may be an interest rate, such as an annual percentage rate (APR), charged to a customer for a loan. The preferred price may be a fee occurring on a regular basis or on a limited basis. Monthly service fees and overdraft fees for a checking account are two examples of such fees. Another example would be the monthly or annual premium for an insurance policy. A further example would be the percentage margin on a foreign exchange or treasury deposit transaction. In some embodiments, the preferred price is an activation fee, a required down payment, or a deposit. In some embodiments, the preferred price is a fee charged under certain circumstances, such as a fee for breaking a contract, a fee assessed on a delinquent account, or a deductible when an insurance claim is filed.

A preferred price may be determined for a variety of products and services. For example, if the price is an interest rate, the interest rate may be associated with a loan or line of credit. Mortgages, car loans, lines of credit, and credit cards are some specific examples. In some embodiments, the transaction is associated with purchasing a service. For example, the transaction may be obtaining insurance (life, home, automobile, health, etc.) or a utility service (a mobile phone service, an internet service provider, a cable/satellite television provider, a gas/electricity provider, etc.). In some embodiments, the transaction is associated with a financial service. For example, the service may be a bank account, a certificate of deposit (CD), a foreign currency exchange, or a brokerage account. Some other examples include content subscription services (such as online music providers and video rentals) and membership fees for clubs. Automated price optimization may be used in banking, credit, insurance, financial services, and a variety of other industries.

Customer information is used by profit model 102 to determine the expected profit. Some examples of the customer information used include a credit score, such as a FICO score, or a credit rating. Level of income, marital status, age, gender, and city/state of residence are other examples of customer information that may be used to determine expected profit. The percentage of customers who accept a price may be considered. This may involve analyzing consumer information relating to income level and spending habits. Costs incurred by customers who purchase a product or service may be considered. For example, if an insurance policy is purchased, claims filed by a customer may affect expected profit. Customer information associated with previous transactions of a similar nature may be used to estimate costs. The number of customers who default on payments may be used to determine expected profit. Customer information associated with previous payment history may be used. In some embodiments, the expected profit is determined using an acceptance rate and a profit per accepted transaction.

In some embodiments, some customer information is not used even if it is available. Laws and regulations may restrict the usage of certain customer information in determining prices. For example, it may be illegal to determine a preferred price based on ethnic background. Customer information associated with ethnic background may not be passed to profit model 102.

In some embodiments, customer information is associated with a subpopulation of interest. For example, an automobile insurance company may determine different insurance premiums for age groups 18-25, 26-40, 41-62, and 63+. For each age group, corresponding customer information is passed to profit model 102. The expected profit output by profit model 102 and the preferred price output by optimization engine 104 are in such cases associated with a particular subpopulation. By repeating the process, a preferred price is determined for each subpopulation. In some embodiments, preferred prices are determined independently of each other. That is, one preferred price does not affect another preferred price. In some embodiments, determination of one preferred price is dependant upon another preferred price.

In addition to customer information, profit model 102 uses information on the product that the customer is interested in purchasing to determine expected profit. For a consumer loan, the product information would include the amount of the loan and the term of the loan. For an insurance policy, it would be the various characteristics of the policy such as the deductible amounts and limitations on coverage.

In addition to customer information and product information, profit model 102 uses feedback from market 106 to determine the expected profit. Feedback information may include the acceptance rate of customers who make a purchase at the preferred price in market 106. In some embodiments, feedback from market 106 includes the total number of customers who accept a preferred price. In some embodiments, there is no feedback from market 106 used by profit model 102. For example, with a new product or service there may be no feedback initially available.

In some embodiments, the preferred price output by optimization engine 104 is not a single value. For example, the preferred price may be a sequence of prices or a multidimensional price. The preferred price may be a two-dimensional price (introductory APR, APR after 12 months). The relationship between elements in a multidimensional price may be described by time. In some embodiments, the elements are related by an event. For example, the price may be the monthly premium for a health insurance plan. A first premium is used so long as certain claims are not filed against the insurance plan. However, if those claims are filed, a second premium is charged to the customer instead of the first premium.

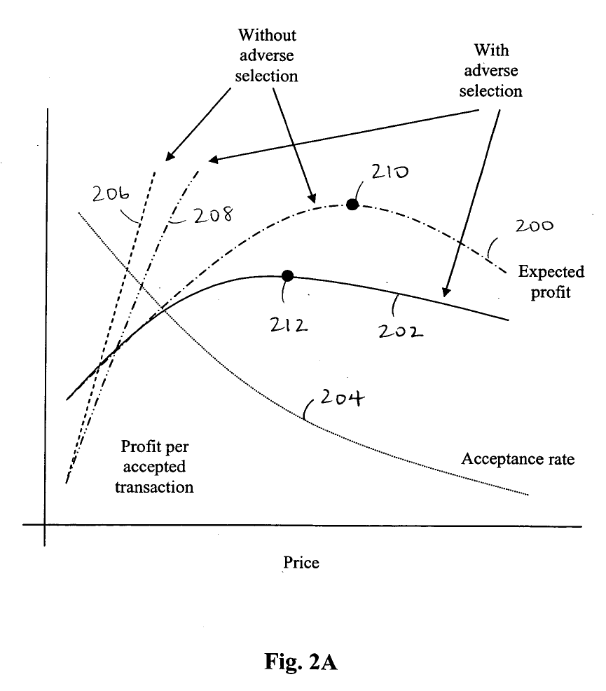

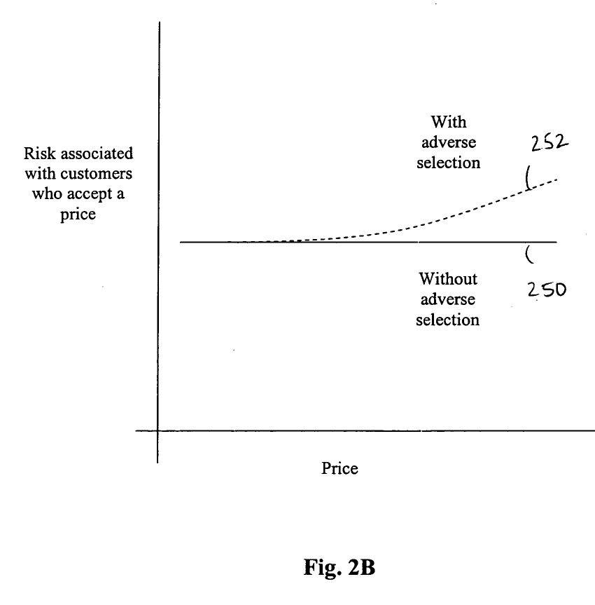

FIG. 2A is a chart illustrating an embodiment of expected profit determined with adverse selection and without adverse selection. In the example shown, expected profits 200 and 202 are functions of price. Expected profit 200 does not consider adverse selection, whereas expected profit 202 considers adverse selection. Expected profit is the product of the acceptance rate and the profit per accepted transaction. Both expected profit 200 and 202 use acceptance rate 204, which is the percentage of customers offered a price who accept that price. As price increases, the percentage of customers accepting the price decreases and acceptance rate 204 decreases. Profit per accepted transaction 206 and 208 are shown without adverse selection and with adverse selection, respectively. With adverse selection, profit per accepted transaction 208 does not increase as quickly as profit per accepted transaction 206.

Adverse selection is the phenomenon in which as price increases, the quality or desirability of customers who accept the price tends to decrease. This corresponds to increased risk associated with customers who accept an increased price. For example, as the interest rate of a loan increases, the average FICO score of customers who accept the loan at the higher interest rate may decrease. This may result in a higher default rate on payments, thus reducing the expected profit. Profit per accepted transaction 208 and expected profit 202 are determined with adverse selection taken into consideration. Preferred prices 210 and 212 are the prices that correspond to the maximum expected profit for each curve. When adverse selection is considered, the price of preferred price 212 is less than the price of preferred price 210.

In some embodiments, the preferred price is used as a customized price. A customized price is a price customized for a customer. A customer may inquire about a product or service, and a provider offers a price for that specific product or service based on customer information. The acceptance rate, information about inquiring customers, and/or information about customers who have historically accepted a price may thus be known. In some embodiments, customized prices are determined before a customer approaches a provider. In some embodiments, segments of customers are defined and a customized price is determined for each segment. A customer who then approaches a provider is classified as a member of one of the segments and the price determined for that segment is offered.

This figure and other figures illustrate continuous functions. In various embodiments, discontinuous functions are also used. For example, a discrete function may be used where expected profit is determined for only certain prices. Piecewise functions may also be used. For example, a first function f₁(price) is used for a first range of prices, and a second function f₂(price) is used for a second range of prices. Discontinuous functions may also be used in which the risk associated with a product jumps at a particular price.

FIG. 2B is a chart illustrating risk associated with customers who accept a price with adverse selection and without adverse selection. In the example shown, risk curve 250 does not account for adverse selection and is constant as price increases. When adverse selection is considered, risk curve 252 tends to increase as price increases. For example, if the price is an interest rate for a credit card, consumers with a strong credit history may increasingly choose a lower-price alternative as the price for the credit card increases. However, consumers with a poor credit history may not have alternatives and may be forced to accept the higher interest rates. As a result, the risk associated with the customers who accept the price increases as the price increases. The price could also be an insurance premium associated with a health insurance plan. Customers who are healthy and do not anticipate undergoing expensive medical procedures may accept an alternative health insurance plan with less expensive premiums or choose not to buy health insurance at all. Customers with existing medical conditions may be willing to pay for higher priced premiums. While the insurance company may seek to exclude some customers with existing medical conditions, there will continue to be some customers, who, unknown to the insurance company have existing medical conditions (so-called “private information”). The existence of these customers means that the insurance company may see its average cost or risk increase as price increases.

In some embodiments, a risk curve is associated with a subpopulation. For example, one risk curve may be used for customers with below average income levels, another risk curve may be used for with customers with average income levels, and another risk curve may be used for customers with above average income levels.

In some embodiments, a risk curve will be associated with combinations of subpopulations and products. For example, one risk curve may be used for customers with below average incomes applying for a $10,000 loan while another risk curve may be used for customers with below average incomes applying for a $15,000 loan while yet another risk curve may be used for customers with above average incomes applying for a $10,000 loan.

As described above, in some embodiments customer segments are defined and an expected profit and a preferred price are determined for each segment and each product or service being offered. A variety of methods may be used to create segments. In some embodiments, segments are defined using one or more dimensions. The figures below describe one example of using dimensions to create segments.

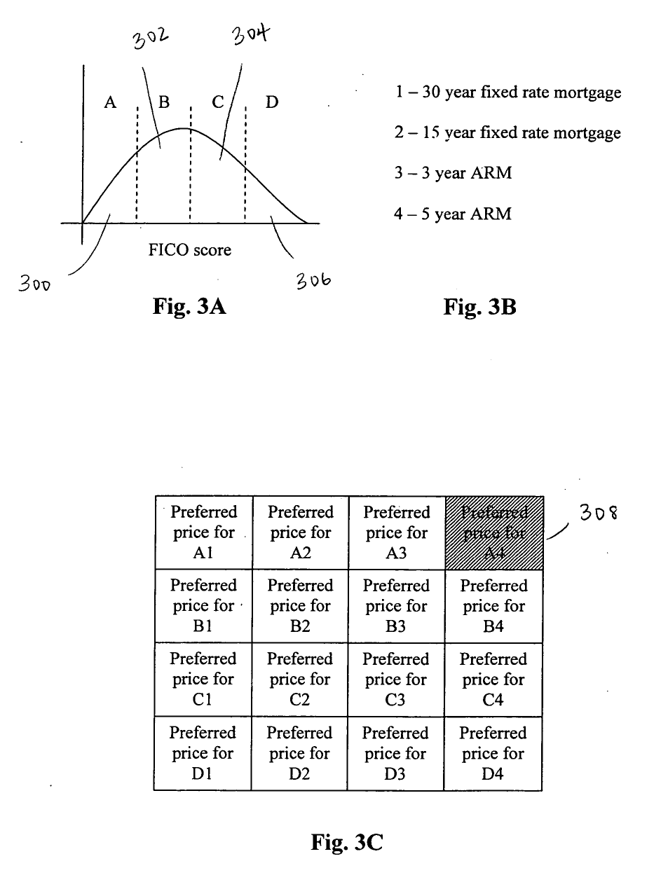

FIG. 3A is a distribution illustrating a customer dimension. In the example shown, customer information is used as a dimension. Four groups of customers are defined based on FICO score. Group A 300 corresponds to customers with the lowest FICO scores. They are the highest risk and have the highest tendency to default on payments. Group D 306 corresponds to customers with the highest FICO scores. They are desirable, low risk customers and have a history of meeting scheduled payments in timely manner. Groups B 302 and C 304 correspond to groups of customers with slightly below average and slightly above average FICO scores, respectively.

FIG. 3B is a description illustrating an embodiment of a product dimension. In the example shown, the product is a mortgage and groups are based on the type of mortgage. For example, group 1 corresponds to 30-year fixed rate mortgages, group 2 corresponds to 15 year fixed rate mortgages, group 3 corresponds to 3 year Adjustable Rate Mortgages (ARM), and group 4 corresponds to 5 year ARMs.

The product dimension and the customer dimension are combined to create segments. The number of segments depends on the number of dimensions and the number of groups in each dimension. In this example, there are 4 groups of FICO scores and 4 groups of mortgage types, so there are 16 (4×4) segments. Although this example illustrates only two dimensions, any number of dimensions may be used to create segments. Similarly, any number of groups may be defined for each dimension. The number of groups defined for one dimension need not equal the number of groups defined for another dimension.

FIG. 3C is a table illustrating an embodiment of preferred prices determined for segments. In the example shown, 16 segments are defined by two dimensions. One dimension includes groups (A, B, C, D) and the other dimension includes groups (1, 2, 3, 4). For example, the first group may be groups of FICO scores and the second group may be based on the type of mortgage. A preferred price is determined for each segment and offered to customers who fall into that segment. If a customer falls into category A and wants a product of type 4, the preferred price 308 for A4 is offered to the customer.

Segments may be created using a variety of dimensions. A dimension may be a customer dimension and use information related to the customer. For example, credit rating, income level, age, payment history, or past repossessions may be used. Dimensions based on product characteristics may be used. For example, if the product is a car loan, the size of the car loan, the nature of the loan (new car loan, used car loan, refinance), or the term of the loan may be used. If the product is a CD, the CD term and the amount deposited may be used. If the product is an insurance policy, the coverage limits, the deductible, or policy coverage options (fire, earthquake, flood) may be used. Payment information may also be used. The repayment method (automatic loan repayment or not), the duration of the payments, and the size of each payment may be used. Customer channel information (i.e., the source of the customer) may be used: that is, whether the customer contacted the offerer via a website, via a telephone number, via a broker, etc.

If the customer is a company, different dimensions may be used to define segments than those described above for an individual. For example, the size of the company or the cash reserves of a company may be dimensions. In some embodiments, the credit rating of a company's debt, such as the credit rating issued by Standard and Poor's, is used as a dimension.

The preferred price may be optimized for other factors in place of or in addition to optimizing profit. For example, a company may wish to maximize revenue from a particular segment or product. In this case the optimized price would be the one that maximized expected revenue rather than expected profit.

The preferred price may need to be subjected to user-defined constraints. For example, a constraint may allow a specified percentage of loans to be at a discounted rate for disadvantaged groups such as the elderly, minorities, or low income groups. Regulatory constraints may be considered in evaluating the preferred price. For example, a regulatory agency may limit the maximum price for a product or service. The maximum price may in some cases be relative to a reference value, such as an initial fee or the prime rate determined by the U.S. Federal Reserve. Another optimization factor may be to optimize market share by adjusting the preferred price selected.

In some embodiments, multiple preferred prices are simultaneously determined. An optimization engine may be configured to determine preferred prices for segments such that the mean or median preferred price satisfies a constraint. In another example, preferred prices are determined for the segments such that the difference between two preferred prices is less than a maximum difference.

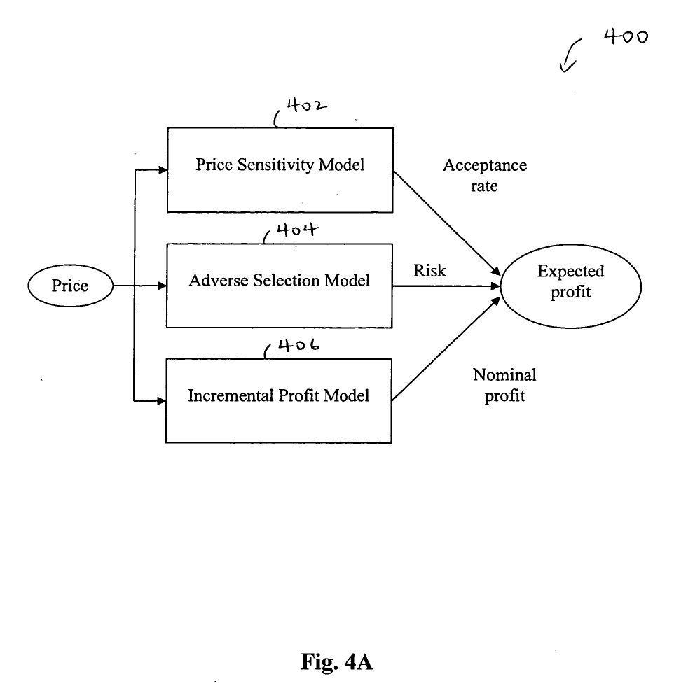

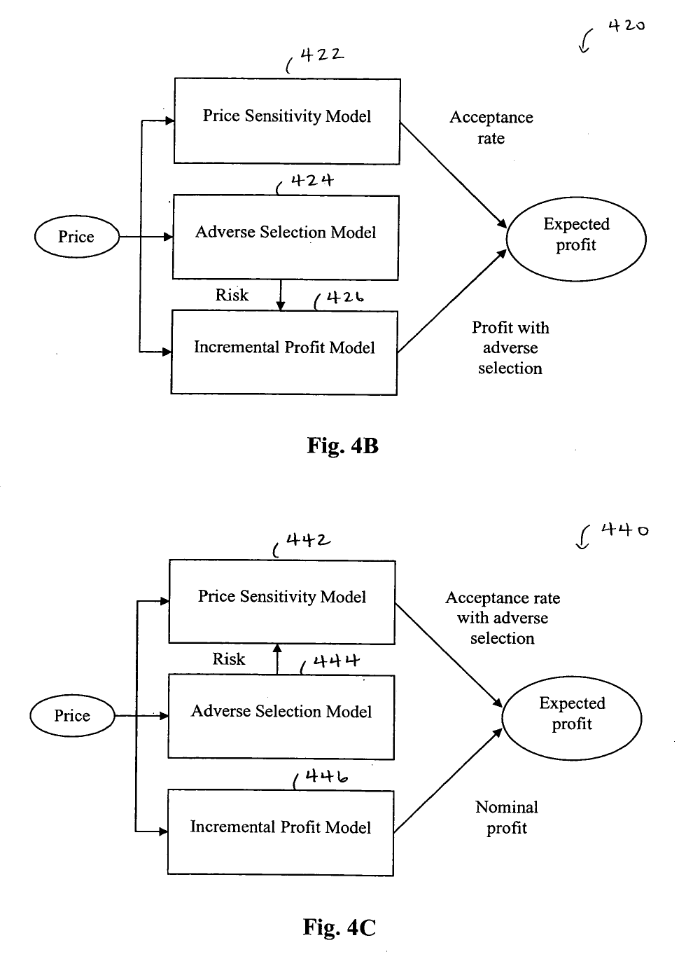

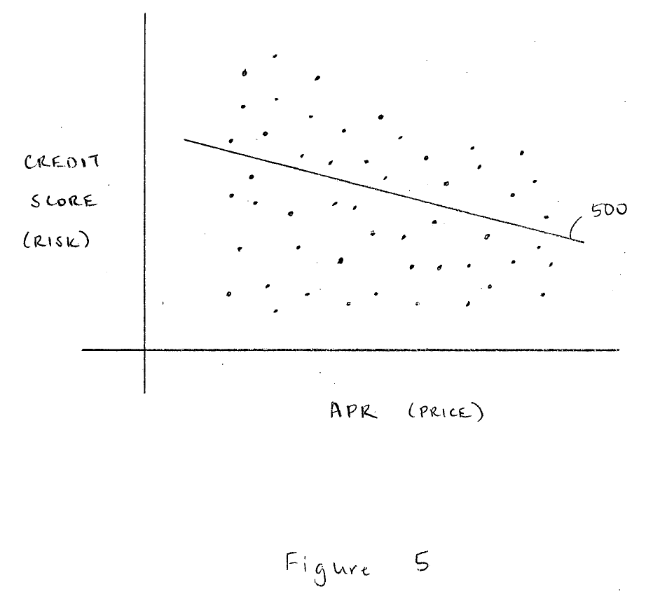

FIG. 4A is a block diagram illustrating an embodiment of a profit model with independent components. In the example shown, profit model 400 outputs an expected profit based on the acceptance rate, risk, and nominal profit. The expected profit output by profit model 400 may be used to determine a preferred price. For example, the price corresponding to the maximum expected profit may be selected as the preferred price.

Profit model 400 includes price sensitivity model 402 which outputs an acceptance rate. The acceptance rate is the percentage of customers offered a price who accept the price or the probability that a customer making an inquiry will accept the offer given the price. As price increases, customers may price compare and opt for lower priced alternatives (or decide not to make a purchase) and the acceptance rate generated by price sensitivity model 402 decreases.

Adverse selection model 404 outputs a measure of risk based on the price. As price increases, risk tends to increase as desirable customers opt for lower priced alternatives, whereas less desirable customers may have fewer alternatives and accept the increased price. The risk associated with customers who accept a price increases as the price increases. A credit score or credit rating, such as a FICO score, may be used to describe the risk associated with customers who accept a price. In some embodiment, risk is modeled as a predicted bad rate for credit. For example, the risk may be defined as an expected fraction of a number of loans that will default or a proportion of an outstanding total loan balance that will default.

There are other embodiments of risk besides risk associated with customers who accept the price. For example, risk may be expressed as an expected loss per transaction. The length of time a customer must remain with the provider for the provider to make a profit may be included in risk. In some embodiments, risk is associated with a scaling factor or a reduction. For example, risk may be some percentage of a nominal value, or may be an amount to be subtracted. In some embodiments, risk is associated with a probability distribution.

Incremental profit model 406 outputs a nominal profit. In some embodiments, the nominal profit is a rate or percentage, such as the nominal profit per accepted transaction. As price increases, nominal profit also tends to increase. Increased payments associated with increased prices may result in increased nominal profit. Other values may be considered in determining nominal profit. The acceptance rate, risk, and nominal profit are combined to generate the expected profit. For example, the three values may be multiplied to produce the expected profit. In general, expected profit is a function of acceptance rate, risk, and nominal profit.

Other embodiments of a profit model besides the embodiment illustrated may be used. In FIG. 4A, price sensitivity model 402, adverse selection model 404, and incremental profit model 406 are independent models. That is, determination of an output from one of the models does not affect determination of an output from another model. In this case, the nominal profit calculated by the incremental profit model assumes a constant risk, independent of the price. The adverse selection model calculates the risk at various prices and the calculation of expected profit combines the risk with the nominal profit to calculate an expected profit including adverse selection. In some embodiments, one model is dependent upon another model.

FIG. 4B is a block diagram illustrating an embodiment of a profit model with an incremental profit model coupled to an adverse selection model. In the example shown, profit model 420 outputs an expected profit based on the acceptance rate and profit with adverse selection. Profit model 420 includes price sensitivity model 422 which outputs an acceptance rate. Adverse selection model 424 and incremental profit model 426 are coupled together. A measurement of risk is output by adverse selection model 424 and is used by incremental profit model 426 to determine a nominal profit that incorporates adverse selection. In some embodiments, the profit with adverse selection is per accepted transaction. The acceptance rate and profit with adverse selection are combined to obtain the expected profit. In some embodiments, they are combined by multiplying the two.

In one example, the measure of risk output by adverse selection model 424 is a FICO score. As price increases, the average FICO score output by adverse selection model 424 has a tendency to decrease. A lower FICO score is associated with higher risk and a reduced desirability of customers who accept a price. Customers with lower FICO scores may be delinquent on payments more often than customers with higher FICO scores. The FICO score is passed to incremental profit model 426 which uses the FICO score to calculate nominal profit including adverse selection.

FIG. 4C is a block diagram illustrating an embodiment of a profit model with a price sensitivity model coupled to an adverse selection model. In the example shown, profit model 440 outputs an expected profit based on an acceptance rate with adverse selection and a nominal profit. Adverse selection model 444 outputs a measure of risk which is passed to price sensitivity model 442. Using risk, an acceptance rate adjusted for adverse selection is determined by price sensitivity model 442. The acceptance rate with adverse selection may be combined with the nominal profit output by incremental profit model 446 which is based on a constant risk measure. The expected profit may, for example, be the product of the acceptance rate with adverse selection multiplied by the nominal profit.

In one example of using risk to determine an acceptance rate with adverse selection, risk is expressed as a percentage of accepting customers who are expected to be profitable for the provider. This percentage may be combined with the percentage of customers who accept a price. For example, for a given price 75% of customers offered that price accept the price. Of the customers who accept that price, 80% are expected to be profitable while the remainder have 0 profit. The adjusted acceptance rate with adverse selection is 60%, the product of the two, and may be multiplied by the nominal profit to determine the expected profit.

In some embodiments, other models are used in place of or in addition to the models described above. One model that may be used is an inertia model. An inertia model may model how existing customers have a tendency to remain with a provider and may be based on price (as price increases, existing customers may be more likely to change), the length of the customer relationship (the longer the customer has had the account, the less likely they may be to change providers), and the number of related accounts (the more related accounts a customer has, the less likely the customer may be to change providers). An inertia model may output a measure of inertia and the measure of inertia may be used to determine expected profit in addition to or in place of some of the elements described above. Elements of customer loyalty or inertia may also be included as customer dimensions.

FIG. 5 is a chart illustrating an embodiment of using a regression to obtain adverse selection data. In the example shown, credit scores of customers are plotted against the APR accepted. This data may be obtained directly from a provider based on their transaction history. In some embodiments, data is used that may be associated with customers who are not customers of the provider. For example, the data may be obtained from a competitor or from a data collection company or from another aggregate data source. Using the credit scores of customers and the APR accepted, regression 500 may be determined using statistical methods. Regression 500 may then be used to determine a credit score (risk) based on APR (price). For example, an adverse selection model may have APR as the price input and a credit score as the risk output. A look up table containing the values captured by regression 500 may be implemented in the adverse selection model. Or, in another embodiment, the values from regression 500 might be directly computed. The results of the regression 500 may be a line, a step-function, or any other function that relates risk to price. As illustrated, an adverse selection model may be based on historical data, such as previous purchases. In some embodiments, a regression is not used but historical data is used. In some embodiments a function representing the dependence of risk on price may be used that is not based on historical data but on the assessment of experts, or on surveys, or conjoint analysis, or other methods.

Other methods may be used to describe adverse selection. For example, a model may be constructed with price as an input and risk as an output. The model is described by a function, risk=f(price), such as a polynomial function, a piecewise function, a step function, an exponential function, etc. The model may be based on empirical (historical) data, expert judgment, experimental results, customer surveys, conjoint analysis or similar methodology, or some combination of two or more of these approaches. In some embodiments, the function is a continuous function. In some embodiments, the function is a discrete function. For example, if the price is an interest rate, then the price may be in units of ⅛^{th} of a percent if prices are offered in such units. In some embodiments, a step function is used. For example, mortgages may be for large amounts of money. To simplify calculations and to reduce the amount of data stored, prices may be grouped in groups of $100, for example: $10,000-$10,099, $10,100-$10,199, etc. The same measurement of risk is output for a $10,000 mortgage as a $10,099 mortgage, but different measurements of risk are output for a $10,099 mortgage compared to a $10,100 mortgage.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of automatically evaluating a price including:
accounting for a price sensitivity effect of the price, wherein increasing the price has a tendency to decrease an acceptance rate;
accounting for an adverse selection effect of the price, wherein increasing the price has a tendency to increase a risk; and
automatically evaluating the price based at least in part on the price sensitivity effect and the adverse selection effect.

2. A method as recited in claim 1, wherein automatically evaluating the price includes determining an expected profit for the price.

3. A method as recited in claim 1, wherein a plurality of prices are automatically evaluated and one of the plurality of prices is selected.

4. A method as recited in claim 1 further including accounting for a payment effect of the price, wherein increasing the price has a tendency to increase a value of a payment and automatically evaluating the price is further based at least in part on the payment effect.

5. A method as recited in claim 1, wherein the price is associated with an insurance product.

6. A method as recited in claim 1, wherein the price is associated with a loan.

7. A method as recited in claim 1, wherein the price is associated with a credit card.

8. A method as recited in claim 1, wherein the price is associated with a line of credit.

9. A method as recited in claim 1, wherein the price is associated with a financial service.

10. A method as recited in claim 1, wherein the price includes a customized price.

11. A method as recited in claim 1, wherein automatically evaluating the price includes optimizing profit.

12. A method as recited in claim 1, wherein accounting for the adverse selection effect includes using a regression of historical data.

13. A method as recited in claim 1, wherein adverse selection is incorporated into the calculation of price-sensitivity by modeling the greater propensity of higher-risk customers to accept higher prices than lower risk customers.

14. A method as recited in claim 1, wherein the adverse selection effect describes a desirability of a population expected to respond positively to the price tending to decrease as the price increases.

15. A method as recited in clam 1, wherein accounting for an adverse selection effect includes generating a FICO score.

16. A method as recited in claim 1, wherein the risk includes a FICO score.

17. A method as recited in claim 1, wherein the risk includes a score other than a FICO score.

18. A method as recited in claim 1, wherein the risk includes an approve rate.

19. A method as recited in claim 1, wherein the risk includes an adjusted predicted bad rate for credit.

20. A method as recited in claim 1, wherein the risk includes an expected claims frequency.

21. A method as recited in claim 1, wherein the risk includes an expected claims severity.

22. A method as recited in claim 1, wherein the risk includes a loss ratio.

23. A method as recited in claim 1, wherein the risk includes an underwriting ratio.

24. A method as recited in claim 1, wherein the risk includes an operating ratio.

25. A method as recited in claim 1, wherein the risk includes a credit ranking.

26. A method as recited in claim 1, wherein the risk includes a loss per deal.

27. A method as recited in claim 1 further including defining a plurality of segments, wherein the price is automatically evaluated for at least one of the plurality of segments.

28. A method as recited in claim 1, wherein automatically evaluating the price is further based at least in part on a business constraint.

29. A method as recited in claim 1 further including using information obtained from offering the price in a feedback loop.

30. A system for automatically evaluating a price including:
a processor configured to:
account for a price sensitivity effect of the price, wherein increasing the price has a tendency to decrease an acceptance rate;
account for an adverse selection effect of the price, wherein increasing the price has a tendency to increase a risk; and
automatically evaluate the price based at least in part on the price sensitivity effect and the adverse selection effect.

31. A system as recited in claim 30, wherein automatically evaluating the price includes determining an expected profit for the price.

32. A system as recited in claim 30, wherein a plurality of prices are automatically evaluated and one of the plurality of prices is selected.

33. A system as recited in claim 30, wherein the price includes a customized price.

34. A system as recited in claim 30, wherein automatically evaluating the price includes optimizing profit.

35. A system as recited in claim 30, wherein the processor is further configured to define a plurality of segments, wherein the price is automatically evaluated for at least one of the plurality of segments.

36. A computer program product for automatically evaluating a price, the computer program product being embodied in a computer readable medium and comprising computer instructions for:
accounting for a price sensitivity effect of the price, wherein increasing the price has a tendency to decrease an acceptance rate;
accounting for an adverse selection effect of the price, wherein increasing the price has a tendency to increase a risk; and
automatically evaluating the price based at least in part on the price sensitivity effect and the adverse selection effect.

37. A computer program product as recited in claim 36, wherein automatically evaluating the price includes determining an expected profit for the price.

38. A computer program product as recited in claim 36, wherein a plurality of prices are automatically evaluated and one of the plurality of prices is selected.

39. A computer program product as recited in claim 36, wherein the price includes a customized price.

40. A computer program product as recited in claim 36, wherein automatically evaluating the price includes optimizing profit.

41. A computer program product as recited in claim 36, the computer program product further comprising computer instructions for defining a plurality of segments, wherein the price is automatically evaluated for at least one of the plurality of segments.
